(19) United States
(12) Patent Application Publication
(10) Pub. No.: US 2009/0248471 A1
(43) Pub. Date: Oct. 1, 2009

(54) METHOD OF BLOCK BOOKING

(75) Inventors: Panos Panay, Watertown, MA (US); John Moore, Winthrop, MA (US); Ford Englander, Boston, MA (US); Harlan North, Arlington, MA (US); William Kent, Brookline, MA (US)

Correspondence Address: HOLLAND & KNIGHT LLP, 10 ST. JAMES AVENUE, BOSTON, MA, 02116-3889, US

(73) Assignee: Sonicbids Corporation, Boston, MA (US)

(21) Appl. No.: 12/057,532

(22) Filed: Mar. 28, 2008

(51) Int. Cl. G06Q 10/00

(52) U.S. Cl. 705/8

(57) ABSTRACT

A method and computer program product for monitoring a performance schedule for one or more of at least one artist and at least one venue. At least one of a performance geographic region of interest and a date range of interest may be defined. At least a second venue may be notified if at least one performance has been scheduled in one or more of the performance geographic region of interest and the date range of interest.

### FIELD OF THE INVENTION

The present disclosure relates to block booking, and more specifically to a method of facilitating block booking.

### BACKGROUND

Venues, such as colleges, bars, stadiums, arenas and other establishments that host live performances, often try to work with artists' existing schedules in an effort to book the artists for performances when they are already planning to be nearby. Similarly, artists often try to book multiple performances at venues located within a given geographic region, especially for convenience and economic reasons. As a result, artists will often offer a discount on their list rate for a single show if they are guaranteed 2 or more shows within a specific area.

However, it is not always easy for venues to determine when or which artists will be nearby at any given time or if they have availability and it is similarly not easy for the artists to determine which venues are seeking performers. One way venues such as colleges have tried to fix this dilemma is to have periodic meetings at which colleges in a similar geographic region try to work together to offer a series of shows to an artist who is touring their area. However, such meetings can be time consuming and often require that the colleges have established a tentative schedule prior to such meetings, though that schedule may not be representative of what the colleges eventually work out. Thus, there exists a need for an efficient method of collaborative or block booking.

### SUMMARY

In a first implementation, a method includes monitoring a performance schedule for one or more of at least one artist and at least one venue. At least one of a performance geographic region of interest and a date range of interest may be defined. At least a second venue may be notified if at least one performance has been scheduled in one or more of the performance geographic region of interest and the date range of interest.

One or more of the following features may be included. An artist performance fee schedule may be provided to the at least a second venue. The artist performance fee schedule may include a cost per performance for one or more performances scheduled in the performance geographic region of interest. The cost per performance may decrease when more than one performance is scheduled for the at least one artist in the performance geographic region of interest. The at least a second venue may be notified if one or more of the cost per performance has changed and if at least one additional performance has been scheduled. The performance fee schedule may be defined by the at least one artist.

The scheduling of at least one performance may be facilitated for the at least one artist. The scheduling of at least one performance may be facilitated for the at least a second venue. The performance geographic region of interest may be at least one of a location and within at least a portion of a mile radius of the location. One or more of the performance geographic region of interest and the date range of interest may be defined by the at least one artist. One or more of the performance geographic region of interest and the date range of interest may be defined by the at least one venue.

According to another implementation, a computer program product resides on a computer readable medium having a plurality of instructions stored thereon. When executed by a processor, the instructions cause the processor to perform operations including monitoring a performance schedule for one or more of at least one artist and at least one venue. At least one of a performance geographic region of interest and a date range of interest may be defined. The instructions also cause the processor to notify at least a second venue if at least one performance has been scheduled in one or more of the performance geographic region of interest and the date range of interest.

One or more of the following features may be included. An artist performance fee schedule may be provided to the at least a second venue. The artist performance fee schedule may include a cost per performance for one or more performances scheduled in the performance geographic region of interest. The cost per performance may decrease when more than one performance is scheduled for the at least one artist in the performance geographic region of interest. The at least a second venue may be notified if one or more of the cost per performance has changed and if at least one additional performance has been scheduled. The performance fee schedule may be defined by the at least one artist.

The scheduling of at least one performance may be facilitated for the at least one artist. The scheduling of at least one performance may be facilitated for the at least a second venue. The performance geographic region of interest may be at least one of a location and within at least a portion of a mile radius of the location. One or more of the performance geographic region of interest and the date range of interest may be defined by the at least one artist. One or more of the performance geographic region of interest and the date range of interest may be defined by the at least one venue.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a block performance booking process coupled to a distributed computing network.

FIG. 2 is a flowchart of a process executed by the block performance booking process of FIG. 1.

### DETAILED DESCRIPTION

### System Overview

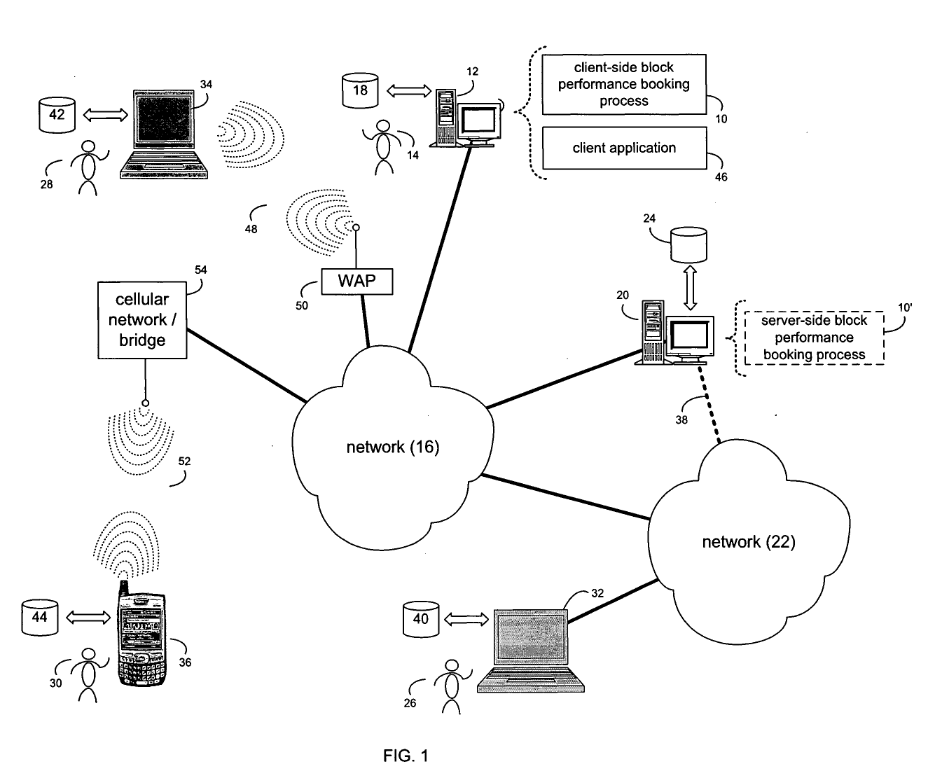

Referring to FIG. 1, there is shown a block performance booking process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, block performance booking process 10 may monitor a performance schedule for at least one artist. Block performance booking process 10 may notify at least one venue if the at least one artist has scheduled at least one performance in a performance geographic region of interest and block performance booking process 10 may facilitate performance scheduling.

Block performance booking process 10 may be a client-side application that resides on and is executed by e.g., client computer 12 accessible by user 14. Client computer 12 may be connected to network 16 (e.g., the Internet). The instruction sets and subroutines of block performance booking process 10, which may be stored on a storage device 18 coupled to client computer 12, may be executed by one or more processors (not shown) and one or more memory architectures (not shown) coupled to client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, block performance booking process 10′ (shown in phantom in FIG. 1) may be a server-based application. Server-side block performance booking process 10′ may reside on and be executed by server computer 20, which may be coupled to network 16. Examples of server computer 20 may include, but are not limited to: a single server computer, a series of server computers, a mini computer, and a mainframe computer, for example. Server computer 20 may execute a network operating system, examples of which may include but are not limited to: Microsoft Windows 2000 Server™; Novell Netware™; or Redhat Linux™, for example.

Server computer 20 may execute a web server application, examples of which may include but are not limited to: Microsoft™, Novell Webserver™, or Apache Webserver™, that allows for HTTP (i.e., HyperText Transfer Protocol) access to server computer 20 via network 16. Network 16 may be coupled to one or more secondary networks (e.g., network 22), examples of which may include but are not limited to: a local area network; a wide area network; or an intranet, for example.

The instruction sets and subroutines of server-side block performance booking process 10′, which may be stored on a storage device 24 coupled to server computer 20, may be executed by one or more processors (not shown) and one or more memory architectures (not shown) coupled to data server 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the block performance booking process may be a client-side application (e.g., client-side block performance booking process 10), a server-side application (e.g., server-side block performance booking process 10′), or a hybrid client-side/server-side application (e.g., using portions of both client-side block performance booking process 10 and server-side block performance booking process 10′). Accordingly, the manner in which the block performance booking process 10, 10′ is accessed may vary depending on whether the block performance booking process 10, 10′ is a client-side application, a server-side application, or a hybrid client-side/server-side application.

Client-side block performance booking process 10 may be accessed by users 14, 26, 28, 30, e.g., directly through the device on which the client-side block performance booking process is executed, namely client computer 12, notebook computer 32, laptop computer 34 and personal digital assistant 36, for example. For the purpose of clarity of the drawings, client-side block performance booking process 10 is only shown associated with computer 12. Client-side block performance booking process 10 may be associated with notebook computer 32, laptop computer 34 and personal digital assistant 36 in a corresponding manner. The instruction sets and subroutines of client-side block performance booking process 10, which may be stored on a storage device (e.g., storage device 18, 40, 42, 44) coupled to the computing device (e.g., client computer 12, notebook computer 32, laptop computer 34 and personal digital assistant 36, respectively) executing client-side block performance booking process 10, may be executed by one or more processors (not shown) and one or more memory architectures (not shown) incorporated into the computing device executing client-side block performance booking process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Server-side block performance booking process 10′ may be accessed by users 14, 26, 28, 30 through network 16 or through secondary network 22. Server computer 20 may be directly coupled to network 16, or may be coupled to network 16 through secondary network 22, as illustrated with phantom link line 38.

Client computer 12, notebook computer 32, laptop computer 34 and personal digital assistant 36 may access server-side block performance booking process 10′, e.g., using a client application (e.g., client application 46) that may interface with server-side block performance booking process 10′ and facilitate the bidirectional transfer of data between e.g., client computer 12 and data server 20. Client application 46 may be a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34 and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### Block Performance Booking Process

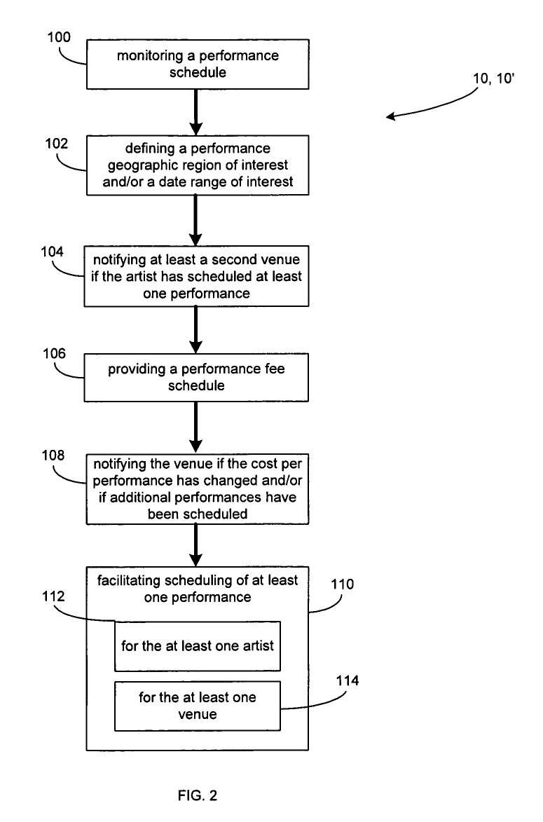

Referring also to FIG. 2, as mentioned above block performance booking process 10 may monitor 100 a performance schedule for one or more of at least one artist and at least one venue. Artists (e.g., user 14) may subscribe to or otherwise participate in block performance booking process 10. For example, an artist who is a member of a music community networking service (e.g., services offered by Sonicbids) may seek a performance for a specified fee and/or within a specified geographic region. A promoter who is a user or member of the music community networking service may search for and book performances with artists through such service. Block performance booking process 10 may be incorporated into such service and may be utilized to monitor artists' and/or venues' performance schedules.

Block performance booking process 10 may define 102 a performance geographic region of interest. The performance geographic region of interest may be predefined as the venue, city, state and/or region in which the at least one artist has scheduled at least one performance and/or where the at least one venue is located. The performance geographic region of interest may be at least one of a location and within at least a portion of a mile/kilometer radius of the location. The performance geographic region of interest may be a specific location or venue, such as a college, bar or concert hall. Additionally/alternatively, the performance geographic region of interest may be a city, state, country or other geographic region. For example, the performance geographic region of interest may be the Orpheum Theater in Boston, or it may be Boston and/or New England. The performance geographic region of interest may also be defined 102 as venues located within a certain radius, such as within half of a mile/kilometer or within five miles/kilometers, of a location. For example, the performance geographic region of interest may be within three miles of the Orpheum Theater in Boston.

Block performance booking process 10 may define 102 a date range of interest. The date range of interest may be defined as a specific date or a specific range of dates. For example, the date range of interest may be defined 102 as Mar. 27 through Mar. 30, 2008. Alternatively, the date range of interest may be defined 102 as Mar. 28, 2008.

The performance geographic region of interest and/or the date range of interest may be defined 102 by the at least one artist. For example, the performance geographic region of interest may be the area in which an artist wants to perform and/or has already scheduled one performance and wants to schedule additional performances. The date range of interest may be the date or range of dates when the artist is available to perform. Alternatively, the date range of interest may be the date or range of dates when the artist plans or wants to be in a specified region. If an artist already has a performance scheduled in Boston, that artist may want to do additional performances in Boston or in New England for a time frame around the date of the scheduled performance. Similarly, the performance geographic region of interest and/or the date range of interest may be defined 102 by the at least one venue. For example, the performance geographic region of interest may be the geographic region for which a venue wants to be notified if any artists schedule a performance in that geographic region. If a venue is located in Boston, the venue may want to be notified about artists who have scheduled performances in Boston or in New England so that the venue can try to schedule a performance by that artist while the artist is in the area or during a time frame around the date of the artist's scheduled performance.

Block performance booking process 10 may notify 104 at least a second venue if at least one performance has been scheduled in one or more of the performance geographic region of interest and the date range of interest. The notification 104 may be accomplished by email, instant message, phone call, regular mail or facsimile. The at least a second venue, which may be a school or college, a bar, a restaurant, a concert hall, an arena or stadium, or a festival, may specify how it would like to be notified 104. The at least a second venue may be notified 104 because it is within the performance geographic region of interest defined 102 by the artist. Alternatively, the at least a second venue may be notified 104 because the artist scheduled a performance in the performance geographic region of interest defined 102 by the venue. Additionally, the at least one venue may be notified 104 again if an artist has scheduled at least one additional performance in the performance geographic region of interest. Similarly, the at least a second venue may be notified 104 because the artist scheduled a performance in the date range of interest defined 102 by the venue. For example, if a venue wants to schedule performances by artists that are scheduling summer tours, the venue may define a date range of interest as June 2008 through September 2008. The venue may be notified 104 if any artists schedule performances during the date range of interest.

Block performance booking process 10 may provide 106 an artist performance fee schedule to the at least a second venue. The artist performance fee schedule may be provided 106 in the notification or it may be provided 106 separately upon request by the venue. The artist performance fee schedule may include pricing information for at least one performance by the artist. The artist performance fee schedule may be defined by the at least one artist. For example, an artist may charge a flat fee regardless of how many performances the artist books. Alternatively, the artist performance fee schedule may include a variable cost per performance depending upon how many performances the artist books. Additionally, the artist performance fee schedule may include variable costs depending upon how much travel is involved for the artist to get from one performance to the next.

The artist performance fee schedule may include a cost per performance for one or more performances scheduled in the performance geographic region of interest. Continuing with the above example, the artist performance fee schedule may vary from region to region. For example, an artist might charge more to play at a large city venue than at a venue in a smaller locale. Similarly, the artist performance fee schedule may vary from night to night. For example, an artist might charge more to play on a Friday or Saturday night, than for a week night performance.

The artist performance fee schedule may also include a variable cost per performance if the artist is able to book more than one performance in the performance geographic region of interest. The cost per performance may decrease when more than one performance is scheduled for the at least one artist in the performance geographic region of interest. For example, the artist may charge $1000 for one performance, but the artist may charge $800 per performance if he is able to book two performances in the performance geographic region of interest. The cost per performance may similarly decrease if additional performances are booked in the performance geographic region of interest.

Block performance booking process 10 may notify 108 the at least one venue if the cost per performance has changed and/or if at least one additional performance has been scheduled. Continuing with the above example, a venue may receive an initial notification 104 that an artist has scheduled a performance in the performance geographic region of interest and/or the date range of interest. The at least a second venue may also receive at least one additional notification 108 if the cost per performance has changed due to the artist scheduling more than one performance in the performance geographic region of interest, per the artist performance fee schedule. Similarly, the at least one venue may receive an additional notice 108 if there has been a change to the artist performance fee schedule for any other reason. Similarly, the at least a second venue may be notified 108 if the artist has scheduled additional performances, for example, outside of or in addition to a specified date range of interest. Receiving additional notices may enable the venue to determine if scheduling the artist is within the venue's budget.

Block performance booking process 10 may facilitate 110 the scheduling of at least one performance for the at least one artist. For example, if an artist wants to schedule a performance at a particular venue or in a particular geographic region, block performance booking process 10 may facilitate 112 scheduling of performances for the at least one artist. Block performance booking process 10 may facilitate 112 scheduling at least one artist by enabling the artist to book a performance online with a venue. Alternatively, block performance booking process 10 may facilitate 112 scheduling for the artist by providing a messaging system for correspondence between the venue and the artist. The messaging system may include an option that the artist may select for automatically adding a performance to the artist's schedule once the artist and venue have agreed on the terms and details of a performance.

Similarly, block performance booking process 10 may facilitate 114 scheduling of at least one performance for the at least a second venue. Block performance booking process 10 may facilitate 112 scheduling for the at least one venue by enabling venues to book the artist when the venue is notified 104, 108 that the artist has scheduled a performance or that the cost per performance has changed. Block performance booking process 10 may enable the venues to book a performance by the artist by providing a way for the venue to contact the artist. Alternatively, block performance booking process 10 may enable the venues to book a performance by the artist by providing an automatic booking option in the notification 104, 108 that the venue may select, which adds the performance to both the artist's and the venue's schedule. The at least one venue may also utilize the automatic booking option provided in the messaging system discussed above to schedule a performance with an artist once the venue and artist have agreed upon terms.

A number of implementations have been described. Nevertheless, it will be understood that various modifications may be made. Accordingly, other implementations are within the scope of the following claims.

What is claimed is:

1. A method comprising:
monitoring a performance schedule for one or more of at least one artist and at least one venue;
defining one or more of a performance geographic region of interest and a date range of interest; and
notifying at least a second venue if at least one performance has been scheduled in one or more of the performance geographic region of interest and the date range of interest.

2. The method of claim 1 further comprising:
providing an artist performance fee schedule to the at least a second venue, the artist performance fee schedule including a cost per performance for one or more performances scheduled in the performance geographic region of interest.

3. The method of claim 2 wherein the cost per performance decreases when more than one performance is scheduled for the at least one artist in the performance geographic region of interest.

4. The method of claim 2 further comprising:
notifying the at least a second venue if one or more of the cost per performance has changed and if at least one additional performance has been scheduled.

5. The method of claim 2 wherein the artist performance fee schedule is defined by the at least one artist.

6. The method of claim 1 further comprising:
facilitating scheduling of at least one performance for the at least one artist.

7. The method of claim 1 further comprising:
facilitating scheduling of at least one performance for the at least a second venue.

8. The method of claim 1 wherein one or more of the performance geographic region of interest and the date range of interest is defined by the at least one artist.

9. The method of claim 1 wherein one or more of the performance geographic region of interest and the date range of interest is defined by the at least a second venue.

10. The method of claim 1 wherein the performance geographic region of interest is at least one of a location and within at least a portion of a mile radius of the location.

11. A computer program product residing on a computer readable medium having a plurality of instructions stored thereon which, when executed by a processor, cause the processor to perform operations comprising:
monitoring a performance schedule for one or more of at least one artist and at least one venue;
defining one or more of a performance geographic region of interest and a date range of interest; and
notifying at least a second venue if at least one performance has been scheduled in one or more of the performance geographic region of interest and the date range of interest.

12. The computer program product of claim 11 further comprising:
providing an artist performance fee schedule to the at least a second venue, the artist performance fee schedule including a cost per performance for one or more performances scheduled in the performance geographic region of interest.

13. The computer program product of claim 12 wherein the cost per performance decreases when more than one performance is scheduled for the at least one artist in the performance geographic region of interest.

14. The computer program product of claim 12 further comprising:
notifying the at least a second venue if one or more of the cost per performance has changed and if at least one additional performance has been scheduled.

15. The computer program product of claim 12 wherein the artist performance fee schedule is defined by the at least one artist.

16. The computer program product of claim 11 further comprising:
facilitating scheduling of at least one performance for the at least one artist.

17. The computer program product of claim 11 further comprising:
facilitating scheduling of at least one performance for the at least a second venue.

18. The computer program product of claim 11 wherein one or more of the performance geographic region of interest and the date range of interest is defined by the at least one artist.

19. The computer program product of claim 11 wherein one or more of the performance geographic region of interest and the date range of interest is defined by the at least one venue.

20. The computer program product of claim 11 wherein the performance geographic region of interest is at least one of a location and within at least a portion of a mile radius of the location.
